(19) United States
(12) Patent Application Publication
(10) Pub. No.: US 2013/0274150 A1
(43) Pub. Date: Oct. 17, 2013

(54) LIGNOSULFONATE GRAFTS WITH AN ACID, ESTER AND NON-IONIC MONOMERS

(71) Applicants: Stuart Holt, Chicago, IL (US); Klin Aloysius Rodrigues, Signal Mountain, TN (US); Jannifer Sanders, Hixson, TN (US)

(72) Inventors: Stuart Holt, Chicago, IL (US); Klin Aloysius Rodrigues, Signal Mountain, TN (US); Jannifer Sanders, Hixson, TN (US)

(73) Assignee: Akzo Nobel Chemicals International B.V., Amersfoort (NL)

(21) Appl. No.: 13/994,889

(22) PCT Filed: Dec. 16, 2011
(86) PCT No.: PCT/EP11/73045

§ 371 Date: Jun. 17, 2013

Related U.S. Application Data
(60) Provisional application No. 61/424,179, filed on Dec. 17, 2010.

(30) Foreign Application Priority Data
Mar. 9, 2011 (EP) 11157421.6

(51) Int. Cl. C09K 8/12

(52) U.S. Cl. CPC C09K 8/12
USPC 507/122; 527/400; 510/476; 510/361; 510/230; 510/515; 510/109; 510/475; 510/220; 510/276

(57) ABSTRACT

The present invention generally relates to controlling the viscosity of water-based mud systems. More particularly, the present invention relates to methods and compositions for thinning and deflocculating aqueous based fluids used in well drilling and other well operations in subterranean formations, especially subterranean formations containing oil and/or gas. The invention also relates to a drilling fluid thinner and/or dispersant having improved temperature stability, dispersing properties and “solids contamination” tolerance.

### FIELD OF THE INVENTION

The present invention generally relates to controlling the viscosity of water based mud systems. More particularly, the present invention relates to methods and compositions for thinning and deflocculating aqueous based fluids used in well drilling and other well operations in subterranean formations, especially subterranean formations containing oil and/or gas. The invention also relates to a drilling fluid thinner and/or dispersant having improved temperature stability, dispersing properties and “solids contamination” tolerance.

### BACKGROUND OF THE INVENTION

A drilling fluid or mud is a specially designed fluid that is circulated through a wellbore as the wellbore is being drilled to facilitate the drilling operation. The various functions of a drilling fluid include removing drill cuttings or solids from the wellbore, cooling and lubricating the drill bit, aiding in support of the drill pipe and drill bit, and providing a hydrostatic head to maintain the integrity of the wellbore walls and prevent well blowouts. Specific drilling fluid systems are selected to optimize a drilling operation in accordance with the characteristics of a particular geological formation.

For a drilling fluid to perform its functions, it must have certain desirable physical properties. The fluid must have a viscosity that is readily pumpable and easily circulated by pumping at pressures ordinarily employed in drilling operations, without undue pressure differentials. The fluid must be sufficiently thixotropic to suspend the cuttings in the borehole when fluid circulation stops. The fluid must release cuttings from the suspension when agitating in the settling pits. It should preferably form a thin impervious filter cake on the borehole wall to prevent loss of liquid from the drilling fluid by filtration into the formations. Such a filter cake effectively seals the borehole wall to inhibit any tendencies of sloughing, heaving or cave-in of rock into the borehole. The composition of the fluid should also preferably be such that cuttings formed during drilling the borehole can be suspended, assimilated or dissolved in the fluid without affecting physical properties of the drilling fluid.

Most drilling fluids used for drilling in the oil and gas industry are water-based muds. Such muds typically comprise an aqueous base, either of fresh water or brine, and agents or additives for suspension, weight or density, oil-wetting, fluid loss or filtration control, and rheology control. Tannins have also been used for deflocculation of water based muds, and are also typically mixed with a heavy metal such as chrome.

Increasingly, drilling fluids have been subjected to greater environmental restrictions and performance and cost demands. Currently, there is a need for deflocculants and/or thinners that can work effectively in freshwater and saltwater based muds, and also be more environmentally compatible or friendlier than chrome or other similar heavy metal containing fluids. The lignosulfonate graft copolymers of the present invention provide an environmentally friendly and economical alternative for currently used technologies which are facing regulatory pressures.

### SUMMARY OF THE INVENTION

The present invention generally relates to controlling the viscosity of water based mud systems. The invention also relates to methods and compositions for thinning and deflocculating aqueous based fluids used in well drilling and other well operations in subterranean formations, especially subterranean formations containing oil and/or gas.

The invention also relates to a drilling fluid thinner and/or dispersant having improved temperature stability, dispersing properties and “solids contamination” tolerance.

### DETAILED DESCRIPTION OF THE INVENTION

The present invention is directed towards a water-soluble copolymer which is a lignosulfonate grafted with at least one of
(a) an olefinically unsaturated carboxylic acid monomer
(b) an olefinically unsaturated mono- or di-alkyl ester of a dicarboxylic acid, and
(c) an olefinically unsaturated hydrophilic, non-ionic monomer.

The co-polymer of the invention is useful in controlling the viscosity of water based mud systems and for thinning and deflocculating aqueous based fluids used in well drilling and other well operations in subterranean formations. It is also useful as a drilling fluid thinner and/or dispersant having improved temperature stability, dispersing properties and “solids contamination” tolerance.

In embodiment of the present invention, the graft copolymers of the invention are produced by reacting or grafting an olefinically unsaturated carboxylic acid monomer, an olefinically unsaturated mono- or di-alkyl ester of a dicarboxylic acid, and an olefinically unsaturated hydrophilic, non-ionic monomer on to the lignosulfonate backbone. These graft copolymers are typically made in water or a mixture of water and optionally a cosolvent. In one embodiment the cosolvent is an alcohol such as isopropanol. The grafting is typically carried out using an initiating system capable of generating a free radical on the lignosulfonate backbone at the temperature of the reaction. Examples of such initiating systems include but are not limited to a combination of metal such as iron, copper, nickel etc and a peroxide such as hydrogen peroxide. The temperatures of the reaction are between ambient and 100° C. and typically between 60° and 95° C. The preferred initiating system is iron which is usually in the form of iron (II) and hydrogen peroxide. The iron (II) can be introduced as a water soluble salt such as ferrous ammonium sulfate or ferrous sulfate.

The olefinically unsaturated carboxylic acid monomer can include at least one monocarboxylic acid monomer or at least one dicarboxylic acid monomer or combinations thereof. In even a further aspect, examples of monocarboxylic acid monomers of the olefinically unsaturated carboxylic acid monomer include acrylic acid, methacrylic acid and combinations thereof. Examples of dicarboxylic acid monomers of the olefinically unsaturated carboxylic acid monomer include, but are not limited to maleic acid, fumaric acid, itaconic acid and combinations thereof.

The olefinically unsaturated mono- or di-alkyl esters of the dicarboxylic acid monomer or constituent include, but are not limited to, alkyl groups having C₁ to C₂₀ hydrocarbons, polyalkoxys, polyalkylene glycol groups, or combinations thereof. In even a further aspect, examples of suitable alkyl groups of the olefinically unsaturated mono- or di-alkyl ester of a dicarboxylic acid monomer include C₁ to C₈ hydrocarbon groups; polyalkoxy groups such as polyethoxy groups, polypropoxy groups, block copolymers of polyethoxy and polypropoxy groups, or combinations thereof. Further, suitable polyalkylene glycol groups include polyethylene glycol groups, polypropylene glycol groups, block copolymers of polyethylene glycol and polypropylene glycol groups, or combinations thereof. The di-alkyl ester of the dicarboxylic acid monomer or constituent of the copolymer can include only one type of alkyl group or two or more different types of alkyl groups.

Alkyl groups of the olefinically unsaturated mono- or di-alkyl esters of a dicarboxylic acid monomer or their amide equivalents include in one embodiment a linear or branched C₁ to C₂₀ hydrocarbon. In another embodiment the alkyl group is a linear or branched C₁-C₈ hydrocarbon. In even another embodiment the alkyl group is a linear or branched C₁-C₄ hydrocarbon group. Alkyl groups can be just one type of alkyl group or a mixture of two or more different alkyl groups. Non-limiting examples include methyl, ethyl, n-_propyl, i-_propyl, n-_butyl, i-_butyl-, t-_butyl, hexyl, cyclohexyl, 2-ethylhexyl, lauryl, stearyl and norbornyl. In one aspect the alkyl groups are methyl, ethyl, butyl and/or 2-_ethylhexyl groups. In another aspect the alkyl groups are mono- and/or di-_alkyl esters of itaconic acid, mono- and/or di-_alkyl esters of maleic acid, mono- and/or di-_alkyl esters of citraconic acid, mono- and/or di-_alkyl esters of mesaconic acid, mono- and/or dialkyl esters of glutaconic acid, and/or mono- and/or di-_alkyl esters of fumaric acid, mono- and/or di-_alkyl maleamides, and/or the reaction product of an alkyl amine with maleic anhydride or itaconic anhydride. In an even further aspect the preferred olefinically unsaturated mono- or di-_alkyl esters of a dicarboxylic acid monomers are mono methyl maleate, di_methyl maleate, mono_ethyl maleate and/or di_ethyl maleate and mixtures thereof.

The olefinically unsaturated hydrophilic, non-ionic monomers of the copolymer include, but are not limited to C₁-C₆ alkyl esters of (meth)acrylic acid and the alkali or alkaline earth metal or ammonium salts thereof, acrylamide and the C₁-C₆ alkyl-substituted acrylamides, the N-alkyl-substituted acrylamides and the N-alkanol-substituted acrylamides, hydroxyl alkyl acrylates and acrylamides. Also useful are the C₁-C₆ alkyl esters and C₁-C₆ alkyl half-esters of unsaturated vinylic acids, such as maleic acid and itaconic acid, and C₁-C₆ alkyl esters of saturated aliphatic monocarboxylic acids, such as acetic acid, propionic acid and valeric acid. In one aspect the nonionic monomers are selected from the group consisting of methyl methacrylate, methyl acrylate, hydroxyethyl (meth)acrylate and hydroxypropyl (meth)acrylate, N,N dimethylacrylamide, N,N diethylacrylamide, N-isopropylacrylamide and acryloyl morpholin. In another embodiment, the non ionic monomers are selected from vinyl and/or allyl alcohols, vinyl and/or allyl amines, (meth)acrylic acid hydroxy alkyl esters, mono- or di-hydroxyalkyl esters of a dicarboxylic acid monomer, N-(di)alkyl (meth)acrylamides, or combinations thereof. The hydroxy alkyl group may contain a C₁ to C₅ alkyl group. In another embodiment, the preferred non ionic monomer is a (meth)acrylic acid hydroxy alkyl ester monomer and is preferably hydroxy ethyl and/or hydroxypropyl (meth)acrylate or combinations thereof.

The initiators used to produce the graft copolymers may be those traditionally used in grafting reactions. These are typically redox systems of a metal ion and hydrogen peroxide. In another aspect, the graft copolymers are made using free radical initiating systems such as ceric ammonium nitrate and Fe (II)/H₂O₂ Fe (II) can be substituted with other metal ions such as Cu (II), Co (III), Mn (III) and others.

The graft copolymers of the invention may be used in a number of oil field applications such as cementing, drilling muds, general dispersancy and spacer fluid applications. These applications are described in some detail below. They can also be employed as scale inhibitors, in water treatment and in fabric and cleaning applications.

### Drilling Fluids

Fluids used in a well bore during drilling operations are generally classified as drilling fluids. The term is generally restricted to those fluids which are circulated in the bore hole in rotary drilling. The rotary system of drilling requires the circulation of a drilling fluid in order to remove the drilled cuttings from the bottom of the hole and thus keep the bit and the bottom of the hole clean. Drilling fluids are usually pumped from the surface down through a hollow drill pipe to the bit and the bottom of the hole and returned to the surface through the annular space outside the drill pipe. Any carvings from the formations already drilled and exposed in the bore hole must be raised to the surface together with the drill cuttings by mud circulation. The casings and larger drill cuttings are separated from the mud at the surface by flowing and mud through the moving screen of a shale shaker and by settling in the mud pits. The flowing drilling fluid cools the bit and the bottom of the hole. The mud usually offers some degree if lubrication between the drill pipe and the wall of the hole. Flows of oil, gas and brines in to the well bore are commonly prevented by overbalancing or exceeding formation pressures with the hydrostatic pressure of the mud column.

One of the primary functions of a drilling mud is the maintenance and preservation of the hole already drilled. The drilling fluid must permit identification of drill cuttings and identification of any shows of oil or gas in the cuttings. It must permit the use of the desired logging materials and other well completion practices. Finally, the drilling fluid should not impair the permeability of any oil or gas bearing formations penetrated by the well.

Most of the drilling fluids are drilling muds which are suspensions of solids in liquids or in solids in liquid emulsions. The densities of such systems are adjusted between 7 and 21 lbs/gal, or 0.85 to 2.5 specific gravity. Where water is used the liquid phase the lower limit of the density is about 8.6 to 9 lbs/gal. In addition to density, other important properties of such suspensions may be adjusted within suitable limits. The filtration quality may be controlled. In addition to density, other important properties of such suspensions may be adjusted within suitable limits. The filtration quality may be controlled by having a portion of the solids consist of particles of such small size and nature that very little of the liquid phase will escape through the filter cake of solids formed around the bore hole. Control over the viscosity and gel forming character of such suspensions is achieved within limits by the amount and kind of solids in the suspension and by the use of chemicals which reduce the internal resistance of such suspensions so that they will flow easily and smoothly. The vast majority of drilling muds are suspension of clays and other solids in water. They are referred to water based muds. Oil based muds are suspensions of solids in oil. High flash point diesel oils are commonly used in the liquids phase and the necessary finely dispersed solid is obtained by adding oxidized asphalt. Common weighting agents are used to increase the density. The viscosity and thixotropic properties are controlled by surfactants and other chemicals. Oil based muds are used for special purposes such as preventing the caving of certain shales and particularly as completion muds for drilling in to sensitive sands which are damaged by water.

Water based muds consists basically of a liquid phase, water and emulsion, a colloidal phase, principally clays, an inert phase principally barite weight material and fine sand and a chemical phase consisting of ions and substances in solution which influence and control the behavior of colloidal materials such as clays.

Colloidal material is necessary in a mud to produce higher viscosities for removing cuttings and cavings from the hole and for suspending the inert materials such as finely ground barite. The Principal material used is bentonite which is a rock deposit. The desirable material in the rock is montmorllionite. In addition, to yielding viscosity and suspending weight material, these clays produce a mud that has low filtration loss. Special clays are used in muds saturated with salt water and these are typically attapulgite. Starch and sodium carboxymethylcellulose are used as auxiliary colloids which supplement the mud properties produced by the clays.

The inert solids in drilling muds include silica, quartz and other inert mineral grains. These inert materials are finely ground weight material and lost circulation materials. The commonly used weight material is barite which has a specific gravity of 4.3. Barite is a soft mineral and therefore minimizes abrasion on the pump valves and cylinders. It is insoluble and relatively inexpensive and therefore is widely used. Lost circulation materials are added to the mud when losses of whole mud occur in crevices or cracks in exposed rocks in the well bore. The commonly used loss circulation materials include shredded cellophane flakes, mica flakes, cane fibers, wood fibers, ground walnut shells and perlite.

The chemical phase of water based muds controls the colloidal phase particularly in the case of bentonite type clays. The chemical phase includes soluble salts which enter the mud from the drill cuttings and the disintegrated portions of the hole and those present in the makeup water added to the mud. The chemical phase also includes the soluble treating chemicals which are used for reducing the viscosity and gel strength of the mud. These chemicals include inorganic materials such as caustic soda, lime, bicarbonate of soda and soda ash. Phosphates such as sodium tetraphosphate may be used to reduce mud viscosities and gel strengths.

In addition to clays and barite, the mud system contains calcium sulfate, a fluid loss reducing agent such as sodium carboxymethylcellulose and suitable surfactants. The surfactants include a primary surfactant which controls the rheological properties (viscosity and gelation) of the mud, a defoamer and an emulsifier.

It is well known that in perforating earthen formations to tap subterranean deposits such as gas or oil, that perforation is accomplished by well drilling tools and a drilling fluid. These rotary drilling systems consist of a drilling bit fitted with appropriate ‘teeth’, then a set of pipes assembled rigidly together end to end, the diameter of which is smaller than that of the drilling bit. This whole rigid piece of equipment, drill bit and drill pipe string, is driven into rotation from a platform situated above the well being drilled. As the drill bit attacks and goes through the geological strata, the crushed mineral materials must be cleared away from the bottom of the hole to enable the drilling operation to continue. Aqueous clay dispersion drilling fluids are recirculated down through the hollow pipe, across the face of the drill bit, and upward through the hole.

The drilling fluid serves to cool and lubricate the drill bit, to raise the drilling cuttings to the surface of the ground, and to seal the sides of the well to prevent loss of water and drilling fluids into the formation through which the drill hole is being bored. After each passage through the well, the mud is passed through a settling tank or trough wherein the sand and drill cuttings are separated, with or without screening. The fluid is then again pumped into the drill pipe by a mud pump.

Some of the most serious problems encountered in producing and maintaining effective clay-based aqueous drilling fluids are caused by the interaction of the mud with the earth formation being drilled. These interactions include contamination of the mud by formation fluids, incorporation into the mud of viscosity producing and inert drilled solids, chemical contamination by drilled solids, or by the infiltration of sea-water and/or fresh water. The conditions of high temperature and pressure inherent with deeper and deeper drilling operations, together with formation interactions, make drilling fluid behavior unreliable and difficult to reproduce.

Characteristics of an ideal drilling fluid would then include the following:
i) To have rheological characteristics as desirable as possible to be able to transport the mineral cuttings set in dispersion.
ii) To allow the separation of cuttings by all known means as soon as the mud flows out of the hole.
iii) To have such required density as to exert sufficient pressure on the drilled geological formations.
iv) To retain its fundamental rheological qualities as it is submitted, in very deep drilling, to higher and higher temperatures.

In one aspect of the present invention, there is provided a method of controlling the viscosity of an aqueous based drilling mud, the method comprising the step of adding the graft copolymers of the invention to water-based drilling muds in an amount effective to control the viscosity of same. In one embodiment, the amount of graft copolymer of the invention is from about 0.1 to 10 weight percent of the aqueous drilling mud composition, in another embodiment from about 0.2 to 5 weight percent of the aqueous drilling mud composition and in still another embodiment from about 0.3 to about 1, in another embodiment 0.4 to about 1, and in another aspect 0.5 to 1 weight percent of the aqueous drilling mud composition.

In another aspect, there is provided a method of thinning and deflocculating aqueous based fluids used in well drilling and other well operations in subterranean formations. In one embodiment, the amount of graft copolymer of this invention is from about 0.1 to about 10 weight percent of the aqueous drilling mud composition, in another embodiment from about 0.2 to 5 weight percent of the aqueous drilling mud composition and in another embodiment from about 0.2 to 1 weight percent of the aqueous drilling mud composition.

Finally, there is provided a drilling fluid thinner and/or dispersant having improved temperature stability, dispersing properties and “solids contamination” tolerance, said dispersant comprising an effective amount of the graft copolymer of the invention. In one embodiment, the amount of graft copolymer of the invention is between about 0.1 to about 10 weight percent of the aqueous drilling mud composition, in another embodiment from about 0.1 to 5 weight percent of the aqueous drilling mud composition and in still another embodiment from about 0.1 to about 1 weight percent of the aqueous drilling mud composition.

### Scale Inhibition in the Oil Field

Among oil field chemicals are scale inhibitors, which are used in production wells to stop scaling in the reservoir rock formation matrix and/or in the production lines downhole and at the surface. Scaling not only causes a restriction in pore size in the reservoir rock formation matrix (also known as ‘formation damage’) and hence reduction in the rate of oil and/or gas production but also blockage of tubular and pipe equipment during surface processing.

In one aspect of the present invention, there is provided a method of inhibiting scaling in an aqueous system, the method comprising the step of adding the graft copolymers of the invention to the aqueous system. The scale inhibitor may be injected or squeezed as described later on or may be added topside to the produced water. The invention also provides a mixture of composition of this invention and a carrier fluid. The carrier fluid may be water, glycol, alcohol or oil. Preferably the carrier fluid is water or brines or methanol. Methanol is often used to prevent the formation of water methane ice structures downhole. In another embodiment, the compositions of the invention are soluble in, for example, methanol. Thus the scale inhibiting polymers can be introduced in to the well bore in the methanol line. This is particularly advantageous since there is fixed number of lines that run in to the wellbore and this combination eliminates the need for another line.

The aqueous system may be any one of a cooling water system, a water flood system and a produced water system. The aqueous environment may also be in crude oil systems or gas systems and may be deployed downhole, topside, pipeline or during refining. The aqueous system may include CO₂, H₂S, O₂, brine, condensed water, crude oil, gas condensate, or any combination or mixture thereof.

The graft copolymer of the invention may be deployed continuously or intermittently in a batch-wise manner. In one embodiment the graft copolymers of the invention are added topside and/or in a squeeze treatment. In the latter, which is also called a “shut-in” treatment, the scale inhibitor is injected into the production well, usually under pressure, and “squeezed” into the formation and held there. In the squeeze procedure, scale inhibitor is injected several feet radially into the production well where it is retained by adsorption and/or formation of a sparingly soluble precipitate. The inhibitor slowly leaches into the produced water over a period of time and protects the well from scale deposition. The “shut-in” treatment needs to be done regularly e.g. one or more times a year at least if high production rates are to be maintained and constitutes the “down time” when no production takes place. The polymers of this invention by virtue of the saccharide functionality which can be absorbed on to the formation and released over time are particularly good for this type of squeeze scale inhibition.

The compositions of this invention can be used for scale inhibition where the scale inhibited is calcium carbonate, halite, calcium sulfate, barium sulfate, strontium sulfate, iron sulfide, lead sulfide and zinc sulfide and mixtures thereof. Halite is the mineral form of sodium chloride, commonly known as rock salt.

### Water Treatment Systems

Water treatment includes prevention of calcium scales due to precipitation of calcium salts such as calcium carbonate, calcium sulfate and calcium phosphate. These salts are inversely soluble, meaning that their solubility decreases as the temperature increases. For industrial applications where higher temperatures and higher concentrations of salts are present, this usually translates to precipitation occurring at the heat transfer surfaces. The precipitating salts can then deposit onto the surface, resulting in a layer of calcium scale. The calcium scale can lead to heat transfer loss in the system and cause overheating of production processes. This scaling can also promote localized corrosion.

Calcium phosphate, unlike calcium carbonate, generally is not a naturally occurring problem. However, orthophosphates are commonly added to industrial systems (and sometimes to municipal water systems) as a corrosion inhibitor for ferrous metals, typically at levels between 2.0-20.0 mg/L. Therefore, calcium phosphate precipitation can not only result in those scaling problems previously discussed, but can also result in severe corrosion problems as the orthophosphate is removed from solution. As a consequence, industrial cooling systems require periodic maintenance wherein the system must be shut down, cleaned and the water replaced. Lengthening the time between maintenance shutdowns saves costs and is desirable.

It is advantageous to reuse the water in industrial water treatment systems as much as possible. Still, water can be lost over time due to various mechanisms such as evaporation. As a consequence, dissolved and suspended solids become more concentrated over time. Cycles of concentration refers to the number of times solids in a particular volume of water are concentrated. The quality of the water makeup determines how many cycles of concentration can be tolerated. In cooling tower applications where water makeup is hard (i.e., poor quality), 2 to 4 cycles would be considered normal, while 5 and above would represent stressed conditions.

One way to lengthen the time between maintenance in a water treatment system is to use polymers that function in either inhibiting formation of calcium salts or in modifying crystal growth. Crystal growth modifying polymers alter the crystal morphology from regular structures (e.g., cubic) to irregular structures such as needlelike or florets. Because of the change in form, crystals that are deposited are easily removed from the surface simply by mechanical agitation resulting from water flowing past the surface. The compositions of the present invention are particularly useful at inhibiting calcium phosphate based scale formation such as calcium orthophosphate. Further, graft copolymers of the invention also modify crystal growth of calcium carbonate scale.

The graft copolymer compositions of the present invention can be added to the aqueous systems neat, or they can be formulated into various water treatment compositions and then added to the aqueous systems. In certain aqueous systems where large volumes of water are continuously treated to maintain low levels of deposited matter, the polymers can be used at levels as low as 0.5 parts per million (ppm). The upper limit on the amount of graft copolymer used depends upon the particular aqueous system treated. For example, when used to disperse particulate matter the compositions can be used at levels ranging from about 0.5 to about 2,000 ppm. When used to inhibit the formation or deposition of mineral scale the graft copolymers of the invention can be used at levels ranging from about 0.5 to about 100 ppm. In another embodiment the compositions can be used at levels from about 3 to about 20 ppm, and in another embodiment from about 5 to about 10 mg/L.

Once prepared, the graft copolymer compositions of the invention can be incorporated into a aqueous water treatment system that includes other water treatment chemicals. These other chemicals can include, for example, corrosion inhibitors such as orthophosphates, zinc compounds and tolyltriazole. The graft copolymer compositions can be used in any aqueous system wherein stabilization of mineral salts is important, such as in heat transfer devices, boilers, secondary oil recovery wells, automatic dishwashers, and substrates that are washed with hard water. The graft copolymer compositions are especially effective under stressed conditions in which other scale inhibitors fail.

The graft copolymer compositions can stabilize many minerals found in water, including, but not limited to, iron, zinc, phosphonate, and manganese. The graft copolymer compositions also disperse particulate found in aqueous systems.

The graft copolymer compositions of the present invention can be used to inhibit scales, stabilize minerals and disperse particulates in many types of processes. Examples of such processes include sugar mill anti-scalant; soil conditioning; treatment of water for use in industrial processes such as mining, oilfields, pulp and paper production, and other similar processes; waste water treatment; ground water remediation; water purification by processes such as reverse osmosis and desalination; air-washer systems; corrosion inhibition; boiler water treatment; as a biodispersant; and chemical cleaning of scale and corrosion deposits.

### Cleaning Formulations

The graft copolymers of the invention can also be used in a wide variety of cleaning formulations containing both phosphate-based builders as well as phosphate free systems. For example, these formulations can be in the form of a powder, liquid or unit doses such as tablets or capsules. Further, these formulations can be used to clean a variety of substrates such as clothes, dishes, and hard surfaces such as bathroom and kitchen surfaces. The formulations can also be used to clean surfaces in industrial and institutional cleaning applications.

In cleaning formulations, the graft copolymers composition can be diluted in the wash liquor to the end use level. The graft copolymers compositions are typically dosed at 0.01 to 1000 ppm in the aqueous wash solutions. The compositions can minimize deposition of phosphate based scale in fabric, dishwash and hard surface cleaning applications. The polymers also help in minimizing encrustation on fabrics. Additionally, the graft copolymers compositions minimize filming and spotting on dishes. Dishes can include glass, plastics, china, cutlery, etc.

Optional components in the detergent formulations include, but are not limited to, ion exchangers, alkalies, anticorrosion materials, anti-redeposition materials, optical brighteners, fragrances, dyes, fillers, chelating agents, enzymes, fabric whiteners and brighteners, sudsing control agents, solvents, hydrotropes, bleaching agents, bleach precursors, buffering agents, soil removal agents, soil release agents, fabric softening agent and opacifiers. These optional components may comprise up to about 90% by weight of the detergent formulation.

The graft copolymers compositions of this invention can be incorporated into hand dish, autodish and hard surface cleaning formulations. The graft copolymers compositions can also be incorporated into rinse aid formulations used in autodish formulations. Autodish formulations can contain builders such as phosphates and carbonates, bleaches and bleach activators, and silicates. In a preferred embodiment, the autodish formulation is free of phosphates for environmental reasons. These formulations can also include other ingredients such as enzymes, buffers, perfumes, anti-foam agents, processing aids, and so forth.

Hard surface cleaning formulations can contain other adjunct ingredients and carriers. Examples of adjunct ingredients include, without limitation, buffers, builders, chelants, filler salts, dispersants, enzymes, enzyme boosters, perfumes, thickeners, clays, solvents, surfactants and mixtures thereof.

One skilled in the art will recognize that the amount of graft copolymer composition needed to be added to the aqueous cleaning system depends upon the cleaning formulation and the benefit they provide to the formulation. In one aspect, the graft copolymers composition is added to the cleaning system at about 1,000 ppm, in another aspect at about 100 ppm and most preferably at about 10 mg/1 ppm.

One skilled in the art can conceive of many other similar applications for which the graft copolymer compositions could be useful.

The invention will now be illustrated by the following non-limiting examples.

### Example 1

### Example of a Graft Lignosulfonate

30.6 grams of monomethylmaleate (olefinically unsaturated mono ester of a dicarboxylic acid) was dissolved in 110 grams of water and as mixed with 340 grams of a 48% solution of lignosulfonate (ARBO S08 from Tembec), 9.4 grams of 50% NaOH solution and 0.1 grams of ferrous ammonium sulfate hexahydrate and heated to 87° C. A monomer solution containing a mixture of 112 grams of acrylic acid and 27.3 grams of hydroxyethyl methacrylate (olefinically unsaturated hydrophilic, non-ionic monomer) mixed with 6.5 grams of water was added to the reactor over a period of 4 hours. An initiator solution comprising of 97 grams of 35% hydrogen peroxide dissolved in 100 grams of water was added over a period of 4 hours. The reaction product was held at 87° C. for 60 minutes. The final product was a dark amber solution and had 38% solids with a residual acrylic acid content of 196 ppm. The weight average molecular weight of the product was 28,795. This polymer solution was spray dried and used in the test below:

### Gypsum/Salt Water Mud

To 325 g of 28% montmorillonite mud were added 5 g gypsum, 4g NaC1 and 2 g of the spray dried polymer of Example 1. The polymer was approximately 0.6% of the aqueous drilling mud composition. This was stirred at low speed for 5 minutes and then adjusted to pH 9.8-9.9 with 50% NaOH. It was then mixed for 15 minutes on a Hamilton Beach milkshake mixer, and the pH was checked to ensure that it was 9.4-9.6. Flow properties were measured on a Fann 35A viscometer. The jar was tightly capped and rolled at 150° F. for 16 hours. The mud was cooled to 72° F. and mixed on the Hamilton Beach milkshake mixer for 5 minutes before determining flow properties on a Fann 35A viscometer.

| | | |
|---|---|---|
| | | 10 min gel |
| Sample | Yield Point | strength |

Unaged

| | |
|---|---|
| Base Mud | 30 |
| Ferrochrome Lignosulfonate | 13 |
| Lignosulfonate Graft of Example 1 | 14 |

Aged

| | | |
|---|---|---|
| Base Mud | 15 | 65 |
| Ferrochrome Lignosulfonate | 4 | 45 |
| Lignosulfonate Graft of Example 1 | 6 | 52 |

These data indicate that the Graft lignosulfonates of this invention perform as well or better than the ferrochrome lignosulfonate which is less desirable from an environmental aspect.

1. A graft copolymer composition comprising at least one graft copolymer containing a lignosulfonate backbone grafted with at least
i. an olefinically unsaturated carboxylic acid monomer,
ii. an olefinically unsaturated mono- or di-alkyl ester of a dicarboxylic acid, and
iii. an olefinically unsaturated hydrophilic, non-ionic monomer.

2. The composition of claim 1 wherein said olefinically unsaturated carboxylic acid monomer is selected from at least one monocarboxylic acid monomer, at least one dicarboxylic acid monomer or combinations thereof.

3. The composition of claim 2 wherein said monocarboxylic acid monomers of the olefinically unsaturated carboxylic acid monomer are selected from acrylic acid, methacrylic acid and combinations thereof, and said dicarboxylic acid monomers of the olefinically unsaturated carboxylic acid monomer are selected from maleic acid, fumaric acid, itaconic acid and combinations thereof.

4. The composition of claim 1 wherein said olefinically unsaturated mono- or di-alkyl esters of the dicarboxylic acid monomer or constituent comprises alkyl groups having C₁ to C₂₀ hydrocarbons, polyalkoxys, polyalkylene glycol groups, or combinations thereof.

5. The composition of claim 4 wherein said alkyl groups of the olefinically unsaturated mono- or di-alkyl ester of a dicarboxylic acid monomer are selected from C₁ to C₈ hydrocarbon groups; polyalkoxy groups, polypropoxy groups, block copolymers of polyethoxy and polypropoxy groups, or combinations thereof, polyalkylene glycol groups selected from polyethylene glycol groups, polypropylene glycol groups, block copolymers of polyethylene glycol and polypropylene glycol groups, or combinations thereof.

6. The composition of claim 1 wherein said olefinically unsaturated hydrophilic, non-ionic monomers are selected from C₁-C₆ alkyl esters of (meth)acrylic acid and the alkali or alkaline earth metal or ammonium salts thereof, acrylamide and the C₁-C₆ alkyl-substituted acrylamides, the N-alkyl-substituted acrylamides and the N-alkanol-substituted acrylamides, hydroxyl alkyl acrylates and acrylamides, C₁-C₆ alkyl esters and C₁-C₆ alkyl half-esters of unsaturated vinylic acids, maleic acid, itaconic acid, and C₁-C₆ alkyl esters of saturated aliphatic monocarboxylic acids, acetic acid, propionic acid and valeric acid.

7. The composition of claim 7 wherein said nonionic monomers are selected from the group consisting of methyl methacrylate, methyl acrylate, hydroxyethyl (meth)acrylate and hydroxypropyl (meth)acrylate, N,N dimethylacrylamide, N,N diethylacrylamide, N-isopropylacrylamide and acryloyl morpholin, vinyl and/or allyl alcohols, vinyl and/or allyl amines, (meth)acrylic acid hydroxy alkyl esters, mono- or di-hydroxyalkyl esters of a dicarboxylic acid monomer, N-(di)alkyl (meth)acrylamides, or combinations thereof.

8. The composition according to claim 1, further comprising at least one of a surfactant, a builder, a cementitious material, a spacer fluid, or a drilling fluid.

9. A spacer fluid formulation comprising the composition of claim 1, wherein the spacer fluid further comprises at least one cement property modifier selected from the group consisting of nonionic water wetting surfactants, anionic water wetting surfactants, retarders, dispersants, densifiers, fluid loss additives, and silica flour.

10. The spacer fluid of claim 9 wherein the spacer fluid further comprises a weighting material selected from the group consisting of barite, hematite, illmenite, calcium carbonate and sand.

11. The spacer fluid of claim 10, wherein the spacer fluid further includes at least one of an anionic surfactant and a nonionic surfactant.

12. A cleaning formulation comprising the graft copolymer composition of claim 1 in an aqueous solution.

13. The cleaning formulation of claim 12 wherein the aqueous solution is a fabric cleaner, an automatic dishwashing detergent, a glass cleaner, a rinse aid, a fabric care formulation, a fabric softener, a flocculant, a coagulants, an emulsion breaker, a hard surface cleaner or a laundry detergent.

14. A water treatment formulation comprising the graft copolymer composition of claim 1.

15. A scale inhibiting composition for use in water treatment and oil field systems comprising the graft copolymer composition of claim 1.

16. An aqueous based drilling mud comprising the graft copolymer composition of claim 1.

17. A method of controlling the viscosity of water based mud systems which comprises adding an effective amount of the graft copolymer composition of claim 1 to said mud system.

18. A method of for thinning and deflocculating aqueous based fluids used in well drilling operations in subterranean formations, said method comprising adding an effective amount of the graft copolymer composition of claim 1 to said aqueous based fluid.
